(19) United States
(12) Patent Application Publication
(10) Pub. No.: US 2026/0292704 A1
(43) Pub. Date: Sep. 24, 2026

(54) NETWORK ENERGY SAVING ENHANCEMENTS

(71) Applicant: MEDIATEK INC., Hsinchu City (TW)

(72) Inventors: Wei-De WU, Hsinchu City (TW); Yi-Ju LIAO, Hsinchu City (TW)

(21) Appl. No.: 19/168,474

(22) PCT Filed: Aug. 13, 2024
(86) PCT No.: PCT/CN2024/111699

§ 371 Date: Sep. 24, 2025

Related U.S. Application Data
(60) Provisional application No. 63/532,506, filed on Aug. 14, 2023.

(51) Int. Cl. H04W 52/02; H04W 24/10; H04W 56/00

(52) U.S. Cl. CPC H04W 52/028; H04W 24/10; H04W 56/003

(57) ABSTRACT

A method for a Base Station (BS) to broadcast one or more Synchronization Signal Blocks (SSBs) is disclosed. The method comprises transmitting a Synchronization Signal Block (SSB) type indication to a user equipment (UE); and broadcasting the one or more SSBs with a reduced number of antennas.

### CROSS-REFERENCE TO RELATED APPLICATIONS

The present Application claims the benefit of U.S. Provisional Patent Application Ser. No. 63/532,506 filed on Aug. 14, 2023, the entire disclosure of which is incorporated herein in its entirety by reference.

### BACKGROUND OF THE INVENTION

### 1. Field of the Invention

This disclosure generally relates to network energy saving enhancements, and more particularly, to network energy saving techniques for a Base Station (BS).

### 2. Description of Related Art

According to a report published by the GSM Association (GSMA), the energy cost on mobile networks accounts for around 23% of the total operator cost. Mobile network operators, therefore, are more and more interested in developing approaches to save energy consumption so as to reduce operational expenditure (OPEX).

For example, several network energy saving techniques, such as SSB-less Secondary Cell (SCell) for inter-band CA (frequency domain), Adaptation of DTX/DRX (time domain), Spatial and power-domain adaptation, Conditional Handover (CHO) enhancement, Cell bar enhancement, etc., are proposed. However, it further needs more network energy saving techniques for a Base Station (BS).

### SUMMARY OF THE INVENTION

In one aspect of the present disclosure, a method for a Base Station (BS) to broadcast one or more Synchronization Signal Blocks (SSBs) is provided. The method comprises transmitting a Synchronization Signal Block (SSB) type indication to a user equipment (UE); and broadcasting the one or more SSBs with a reduced number of antennas.

In another aspect of the present disclosure, a method for a User Equipment (UE) to receive one or more Synchronization Signal Blocks (SSBs) is provided. The method comprises receiving a SSB type indication from a Base Station (BS); and receiving the one or more SSBs broadcasted with a reduced number of antennas from the BS.

In yet another aspect of the present disclosure, the BS broadcasts the one or more SSBs with a reduced power level and with the reduced number of antennas.

In yet another aspect of the present disclosure, the UE, in response to the one or more SSBs are broadcasted with the reduced power level, adjusts its beam measurement behavior and report behavior in accordance with the SSB type indication, including adjusting Radio Link Monitoring (RLM) or Beam Failure Detection (BFD) thresholds, calculating an accumulated power level over multiple SSBs, or compensating measured SSB power with a provided power offset value.

In yet another aspect of the present disclosure, the BS broadcasts the one or more SSBs in a reduced power level with potentially extended periodicity.

In yet another aspect of the present disclosure, one or more PBCHs of the one or more SSBs are excluded to form a discovery reference signal for maintaining UE synchronization and providing the UE with coarse cell quality information, which can be used to trigger an on-demand SSB. The BS broadcasts these SSBs in a reduced power level with potentially extended periodicity.

In yet another aspect of the present disclosure, the BS implements an on-demand SSB design function wherein no SSB transmission occurs if not triggered. This function can be used to further reduce power consumption when there is low or no cell load.

These and other features and advantages of the present disclosure can be more readily understood from the following embodiments with reference to the appended drawings.

### BRIEF DESCRIPTION OF THE DRAWINGS

FIG. 1 illustrates a Base Station (BS) broadcasts a plurality of Synchronization Signal and Physical Broadcast Channel (SS/PBCH) blocks (SSBs) on different beams consuming power at a first power level.

FIG. 2 illustrates a Base Station (BS) is in a sleep mode consuming power at a second power level.

FIG. 3 illustrates a Base Station (BS) broadcasts a plurality of SSBs consuming power at a third power level.

FIG. 4 illustrates how a Base Station (BS) transmits SSB related information to those UEs in the idle/inactive mode.

FIG. 5 illustrates how a Base Station (BS) transmits SSB related information to those UEs in the connected mode.

FIG. 6 illustrates a method for a Base Station (BS) to broadcast one or more Synchronization Signal Blocks (SSBs).

FIG. 7 illustrates a method for a User Equipment (UE) to receive one or more Synchronization Signal Blocks (SSBs).

### DETAILED DESCRIPTION OF THE DRAWINGS

The present disclosure is not intended to be limited to the embodiments shown below, but is to be accorded the principles disclosed herein. Furthermore, that various modifications or changes in light thereof will be suggested to a person having ordinary skill in the art and are to be included within the spirit and purview of this application and scope of the appended claims.

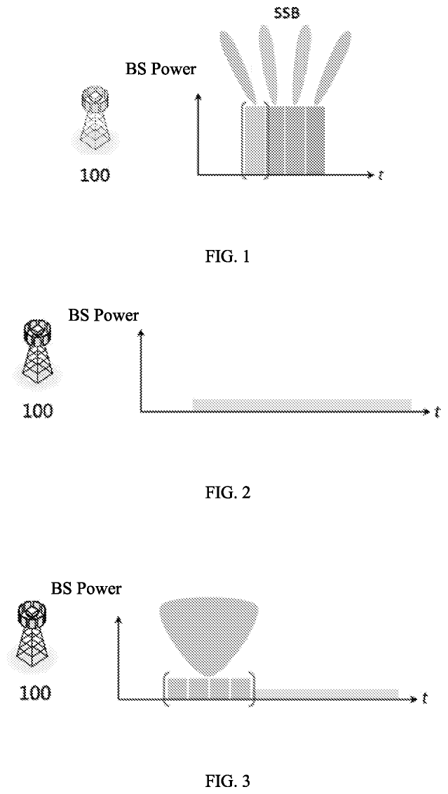

Now please refer to FIG. 1 which illustrates a Base Station (BS) (100) broadcasts one or more Synchronization Signal and Physical Broadcast Channel (SS/PBCH) blocks (SSBs) on different beams in a first power level.

The BS (100) may periodically broadcast one or more SSBs, comprising a Primary Synchronization Signal (PSS), a Secondary Synchronization Signal (SSS), a Physical Broadcast Channel (PBCH) signal, and/or a PBCH Demodulation Reference Signal (DM-RS), to a plurality of User Equipment (UEs) in a cell of the BS (100).

The PBCH signal (or simplified as PBCH) may comprise a current System Frame Number (SFN) of the cell of the BS (100) and a SSB timing index to facilitate time synchronization of UE to the BS (100). The PBCH may also comprise a Master Information Block (MIB) having one or more parameters. The UE can locate Remaining Minimum System Information (RMSI) associated with the cell based on the parameters of the MIB. The RMSI may comprise a System Information Block type 1 (SIB1). The SIB1 may comprise information for the UE to access the cell. In addition, the UE can monitor a PDCCH based the parameters of the MIB, which can be used to schedule a PDSCH.

During the process of selection of a cell, the UE decodes the SIB1 of each detected cell. The US camps on the cell which is selected by a selection mechanism based on the parameters contained in each of SIB1 of each detected cell.

During the process of reselection of a cell, the UE has to decode other SIB1 transmitted by the cell on which it is to be camped because the UE was previously camped on a cell. The other SIB1 can be transmitted on demand.

In addition, SSBs may comprise a System Information Block type 2 (SIB2) to facilitate intra-frequency cell reselection and a System Information Block type 4 (SIB4) to facilitate inter-frequency cell reselection.

Back to FIG. 1, in order to achieve a wider coverage of the BS (100), the BS (100) can broadcast a set of SSBs in a SSB burst (4 SSBs as illustrated in FIG. 1 as an example) with a first power level in 4 beams directed to different direction when there is high cell load, which means there are numbers of UEs in connected mode with regard to the cell of the BS (100). The 4 SSBs in the SSB burst are transmitted by utilizing the time-division multiplexing technique. It can be seen that it costs more power for the BS (100) if there are more beams used to broadcast SSBs.

The UEs receive the SSBs for time and frequency synchronization with the cell of the BS (100). The UEs can report measurements of the reference signals associated with one or more beams to the BS (100). For example, the UEs may report measurements of the reference signals associated with the best beam or the first two best beams.

Now please refer to FIG. 2 which illustrates the BS (100) is in a sleep mode. In order to save power, the BS (100) may fall into the sleep mode when there is empty load, which means there is no UE or idled/inactive UEs in the cell of the BS (100). When the BS (100) is in the sleep mode, it costs power at a second power level which is much lower than the first power level for implementation of, for example, an on-demand SSB mechanism which allows the idled/inactive UEs (i.e. UEs in an idle/inactive mode) to request SSBs when needed (details please refer to 3GPP release 19). In other words, there is no SSB transmission occurs if not triggered during the on-demand SSB mechanism.

Now please refer to FIG. 3 which illustrates the BS (100) broadcasts a plurality of SSBs in a third power level. In order to further save power, the BS (100) may broadcast SSBs with a reduced number of antennas when there is low cell load, which means there are few UEs in connected mode with regard to the cell of the BS (100). As shown in FIG. 1, the BS (100) broadcasts 4 SSBs with 4 antennas when there is high cell load. In contrast, the BS (100) broadcast 4 SSBs with a reduced number of antennas when there is low cell load, for example, with a single antenna or 2 antennas. In one case, the BS (100) may choose to broadcast 4 SSBs in one or more wilder beams. In another case, the BS (100) may choose to broadcast 4 SSBs in a third power level which is lower than the first power level and higher than the second power level with a reduced number of antennas. In yet another case, the BS (100) may choose to broadcast 4 SSBs in one or more wilder beams and in the third power level.

The BS (100) can broadcast the SSBs in the third power level with potentially extended periodicity. The PBCH in the SSBs can be excluded to form a Discovery Reference Signal (DRS) for maintaining synchronization for UEs and providing UEs with coarse cell quality information, which can then be used to trigger an on-demand SSB.

The UEs receive the SSBs which were transmitted from the BS (100) with the third power level. In avoidance of the situation that the UEs might determine all the received beams should be failed because the power levels of the received beams are quite low, the BS (100) needs to inform the UEs of that the SSBs was transmitted in a reduced power level, say the third power level, in advance. In one case, a SSB type indication and/or a SSB related configuration (e.g. via a SIB or RRC) is transmitted from the BS (100) to the UEs before SSBs are broadcasted. In another case, a SSB type indication and/or a SSB related configuration is transmitted from the BS (100) together with SSBs, which means the UEs could distinguish whether SSBs are transmitted in the first power level or the third power level upon receiving broadcasting information of the BS (100).

In terms of a UE, the aforementioned SSB related configuration is transmitted from the BS (100) via a SIB for those UEs in the idle/inactive mode and via a RRC for those UEs in the connected mode.

In addition, the SSB type indication is higher-layer information transmitted by the BS (100).

In addition, the SSB type indication can be used to indicate adjustment of a Radio Link Monitoring (RLM) threshold or a Beam Failure Detection (BFD) threshold for the UEs in one case. The UEs can adjust the RLM threshold or BFD threshold based on the SSB type indication. Accordingly, the UEs would not determine link or beam failures if lowering the thresholds.

In addition, the SSB type indication can be used to request the UEs to send a measurement report for multiple received beams associated with the SSBs. The measurement report contains an accumulated power level which is calculated based on the power levels of the SSBs measured by the UEs in another case. Accordingly, the UEs would not determine beam failures if accumulating several received power levels and could estimate the best beam power with beamforming.

The aforementioned accumulated power level associated with the SSBs in this case can be calculated over multiple SSB occasions in one SSB burst or can be calculated over multiple SSB occasions in more than one SSB bursts.

In addition, the SSB type indication can be used to provide a power offset value for UEs in the connected mode. The UEs may compensate the power levels of received SSBs with the power offset value per beam in another case. Accordingly, the UEs would not determine beam failures if compensating the power levels.

In such case, the UEs may send a measurement report, including a measurement outcome based on the measured SSB power and the provided power offset value, to the BS (100).

In addition, the SSB type indication can be used to indicate adjustment of a cell re-selection threshold in a SIB, such as SIB1, SIB2 or any other SIB, for the UEs. The UEs can adjust the re-selection threshold based on the SSB type indication. Accordingly, the UEs would not determine beam failures which results in undesired cell re-selection if increasing the threshold.

Given the above, the BS (100) can indicate the UEs how to adjusts their beam measurement behavior and report behavior. For example, the BS (100) can perform any one or any combination of the following methods: (a) indicating the UEs to adjust the RLM threshold or BFD threshold; (b) requesting the UEs to report an accumulated power level for multiple beams and estimate the best beam power with beamforming; and/or (c) providing a power offset value and requesting the UEs in connected mode to compensate the power level of the received SSBs measured by the UEs in connected mode.

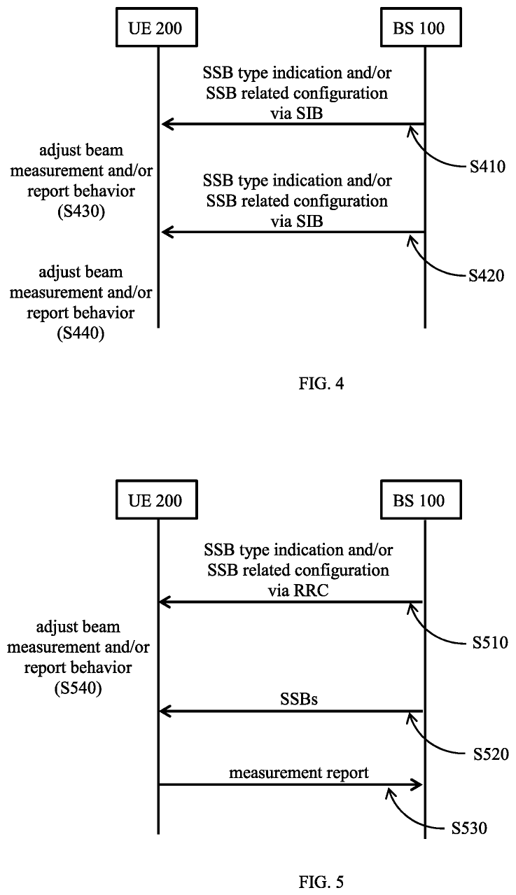

Now please refer to FIG. 4 which illustrates how the BS (100) transmits SSB related information to those UEs (200) in the idle/inactive mode. As shown in the FIG. 4, the BS (100) transmits a SSB type indication and/or a SSB related configuration via a SIB (S410) to the UEs (200). The BS (100) then transmits a SSB type indication and/or a SSB related configuration via a SIB (S420) to the UEs (200) after a predetermined period. That is, the BS (100) periodically transmits the SSB type indication and/or the SSB related configuration via a SIB, such as a SIB1 or SIB2 to the UEs (200) in the idle/inactive mode.

The UEs (200) in the idle/inactive mode are not required to send a measurement report for the received beams. The UEs (200) are required to adjust their beam measurement and/or report behavior in accordance with the indication and/or configuration of SSB type. For example, the UEs (200) can increase the threshold of cell re-selection in response to the situation that the SSBs are transmitted in a reduced power level. Specifically, the UEs (200) adjust their beam measurement and/or report behavior (S430) in accordance with the indication and/or configuration of SSB type associated with S410. In addition, the UEs (200) further adjust their beam measurement and/or report behavior (S440) in accordance with the indication and/or configuration of SSB type associated with S420.

Now please refer to FIG. 5 which illustrates how the BS (100) transmits SSB related information to those UEs (200) in the connected mode. The UEs in the connected mode means they have successfully established a RRC connection with the network. As shown in the FIG. 5, the BS (100) transmits a SSB type indication and/or a SSB related configuration via a RRC (S510) to the UEs (200).

In one case, the SSB type indication and/or configuration informs the UEs (200) that the SSBs will be transmitted in the first power level. In such case, the BS (100) broadcasts the SSBs with the first power level (S520) to the UEs (200). The UEs (200) then receives the SSBs and measures the power levels of the received SSBs. The UEs (200) then sends a measurement report for multiple beams associated with the SSBs (S530). The measurement report indicates the best beam or the first two best beams.

In another case, the SSB type indication and/or configuration informs the UEs (200) that the SSBs will be transmitted in a reduced power level, i.e. the third power level. In such case, in response to the situation that the SSBs are transmitted in a reduced power level, the UEs (200) are required to adjust their beam measurement and report behavior in accordance with the indication and/or configuration of SSB type (S540). For example, the connected-mode UEs (200) can correspondingly lower the thresholds of RLM and BFD, increase the threshold of cell re-selection, or compensate the power level with a power offset value to avoid the occurrence of inappropriate cell re-selection. Furthermore, in such case, the BS (100) broadcasts the SSBs with the third power level (S520) to the UEs (200). The UEs (200) then receives the SSBs and measures the power levels of the received SSBs. The UEs (200) then sends a measurement report for multiple beams associated with the SSBs (S530). The measurement report for multiple beams associated with the SSBs contains an accumulated power level calculated based on the power levels of SSBs measured by the UEs (200).

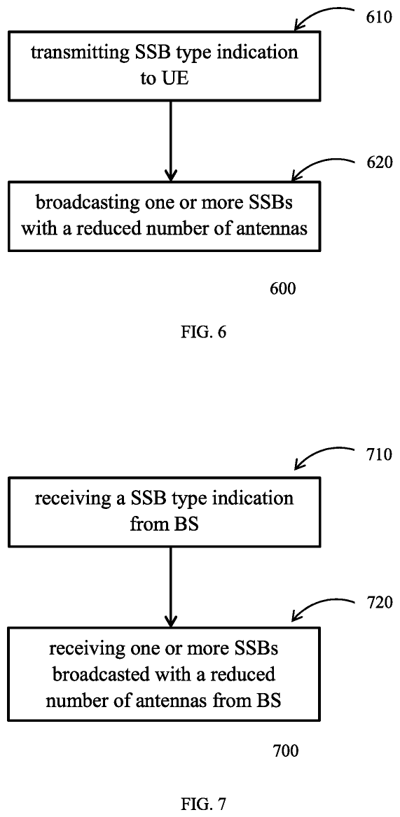

Given the above, the BS behavior and the UE behavior can be illustrated in FIGS. 6 and 7.

In FIG. 6, a method (600) for a BS to broadcast one or more Synchronization Signal Blocks (SSBs) is illustrated. The method (600) comprises transmitting a SSB type indication to a UE (step 610); and broadcasting the one or more SSBs with a reduced number of antennas (step 620).

In FIG. 7, a method (700) for a UE to receive one or more Synchronization Signal Blocks (SSBs) is illustrated. The method (700) comprises receiving a SSB type indication from a Base Station (BS) (step 710); and receiving the one or more SSBs broadcasted with a reduced number of antennas from the BS (step 720).

The embodiments of the present invention have been described above. However, those having ordinary skill in the art readily recognize that the disclosure described above can be utilized in a variety of devices, environments, and situations. Although the present invention is written with respect to specific embodiments and implementations, various changes and modifications may be suggested to a person having ordinary skill in the art. It is intended that the present disclosure encompass such changes and modifications that fall within the scope of the appended claims.

For example, those having ordinary skill in the art would understand that a device may include a processor, memory in electronic communication with the processor, and instructions stored in the memory. The instructions are used to perform the methods in accordance with the embodiments above.

For example, those having ordinary skill in the art would understand that though the network energy saving techniques for a Base Station (BS) have been introduced as above, a User Equipment (UE) can correspondingly save power as well. For example, the UE can be equipped with a low-power wake-up receiver (LP-WUR), which allows the UE to monitor the wake-up receive (WUR) only and thus a main receiver (MR) can be kept in a sleep mode to substantially save power of the UE. More frequently measuring/accumulating SSB power can be realized with reduced UE power consumption than the MR. To maximize the LP-WUR benefit, the BS can further provide a low-power paging indication and/or a low-power synchronization signal so that the LP-WUR can be operated as longer as possible, while MR can be waken-up whenever necessary.

For example, those having ordinary skill in the art would understand that even though the UE can adjust its beam measurement behavior and beam report behavior in accordance with the SSB type indication in response to the one or more SSBs are broadcasted with the reduced power level and then detect the beams in the reduced power level associated with the one or more SSBs, it dose not work if the UE cannot transmit the measurement report on a uplink channel. To solve this problem, a relaxed measurement requirement can be considered for a higher operating SNR condition.

What is claimed is:

1. A method for a Base Station (BS) to broadcast one or more Synchronization Signal Blocks (SSBs), the method comprising:
transmitting a Synchronization Signal Block (SSB) type indication to a user equipment (UE); and
broadcasting the one or more SSBs with a reduced number of antennas.

2. The method of claim 1, wherein the BS broadcasts the one or more SSBs with a reduced power level with the reduced number of antennas.

3. The method of claim 1, wherein the SSB type indication indicating adjustment of a Radio Link Monitoring (RLM) threshold or a Beam Failure Detection (BFD) threshold for the UE.

4. The method of claim 1, the method further comprising:
receiving a measurement report for multiple beams associated with the one or more SSBs, and wherein the measurement report contains an accumulated power level calculated based on one or more power levels of the one or more SSBs measured by the UE.

5. The method of claim 4, wherein the accumulated power level is calculated over multiple SSB occasions in a SSB burst or more than one SSB bursts.

6. The method of claim 2, the method further comprising:
providing a power offset value to the UE.

7. The method of claim 6, the method further comprising:
receiving a measurement outcome based on the measured SSB power and the provided power offset.

8. The method of claim 1, the SSB type indication indicating a cell re-selection threshold in a System Information Block (SIB).

9. The method of claim 1, the method further comprising:
implementing an on-demand SSB design function wherein no SSB transmission occurs if not triggered.

10. The method of claim 3, wherein the BS broadcasts the one or more SSBs in a reduced power level with potentially extended periodicity and one or more PBCHs of the one or more SSBs are excluded to form a discovery reference signal for maintaining UE synchronization and providing the UE with coarse cell quality information, which can be used to trigger an on-demand SSB.

11. A method for a User Equipment (UE) to receive one or more Synchronization Signal Blocks (SSBs), the method comprising:
receiving a SSB type indication from a Base Station (BS); and
receiving the one or more SSBs broadcasted with a reduced number of antennas from the BS.

12. The method of claim 11, wherein the one or more SSBs are broadcasted with a reduced power level with the reduced number of antennas from the BS.

13. The method of claim 11, wherein the SSB type indication indicating adjustment of a Radio Link Monitoring (RLM) threshold or a Beam Failure Detection (BFD) threshold for the UE.

14. The method of claim 11, the method further comprising:
sending a measurement report for multiple beams associated with the one or more SSBs, and wherein the measurement report contains an accumulated power level calculated based on one or more power levels of the one or more SSBs measured by the UE.

15. The method of claim 14, wherein the accumulated power level is calculated over multiple SSB occasions in a SSB burst or more than one SSB bursts.

16. The method of claim 12, the method further comprising:
receiving a power offset value sent from the BS.

17. The method of claim 16, the method further comprising:
sending a measurement outcome based on the measured SSB power and the received power offset.

18. The method of claim 11, wherein the SSB type indication indicating a cell re-selection threshold in a System Information Block (SIB).

19. The method of claim 11, the method further comprising:
implementing an on-demand SSB design function wherein no SSB transmission occurs if not triggered.

20. The method of claim 13, wherein the BS broadcasts the one or more SSBs in a reduced power level with potentially extended periodicity and one or more PBCHs of the one or more SSBs are excluded to form a discovery reference signal for maintaining UE synchronization and providing the UE with coarse cell quality information, which can be used to trigger an on-demand SSB.
